(19) United States
(12) Patent Application Publication
(10) Pub. No.: US 2018/0375743 A1
(43) Pub. Date: Dec. 27, 2018

(54) DYNAMIC SAMPLING OF SENSOR DATA

(71) Applicants: Guang-He LEE, Taipei (TW); Shao-Wen YANG, New Taipei (TW); Intel Corporation, Santa Clara, CA (US)

(72) Inventors: Guang-He Lee, Taipei (TW); Shao-Wen Yang, San Jose, CA (US)

(73) Assignee: Intel Corporation, Santa Clara, CA (US)

(21) Appl. No.: 16/062,107

(22) PCT Filed: Dec. 26, 2015
(86) PCT No.: PCT/US2015/000390

§ 371 Date: Jun. 14, 2018

(51) Int. Cl. H04L 12/26; H04L 29/08; G06F 17/16; G06K 9/62

(52) U.S. Cl. CPC H04L 43/024; H04L 67/04; G06K 9/6298; G06F 17/16; H04L 67/2828

(57) ABSTRACT

A plurality of sensor data instances from a sensor device are identified and one or more tensors for a data set based on the plurality of sensor data instances is determined. A predicted value for each instance in the data set based on the tensors, as well as a predicted variance for each instance in the data set. A sampling rate to be applied at the sensor device is determined based on the predicted variances.

### TECHNICAL FIELD

This disclosure relates in general to the field of computer systems and, more particularly, to data analytics.

### BACKGROUND

The Internet has enabled interconnection of different computer networks all over the world. While previously, Internet-connectivity was limited to conventional general purpose computing systems, ever increasing numbers and types of products are being redesigned to accommodate connectivity with other devices over computer networks, including the Internet. For example, smart phones, tablet computers, wearables, and other mobile computing devices have become very popular, even supplanting larger, more traditional general purpose computing devices, such as traditional desktop computers in recent years. Increasingly, tasks traditionally performed on a general purpose computers are performed using mobile computing devices with smaller form factors and more constrained features sets and operating systems. Further, traditional appliances and devices are becoming “smarter” as they are ubiquitous and equipped with functionality to connect to or consume content from the Internet. For instance, devices, such as televisions, gaming systems, household appliances, thermostats, automobiles, watches, have been outfitted with network adapters to allow the devices to connect with the Internet (or another device) either directly or through a connection with another computer connected to the network. Additionally, this increasing universe of interconnected devices has also facilitated an increase in computer-controlled sensors that are likewise interconnected and collecting new and large sets of data. The interconnection of an increasingly large number of devices, or “things,” is believed to foreshadow a new era of advanced automation and interconnectivity, referred to, sometimes, as the Internet of Things (IoT).

### BRIEF DESCRIPTION OF THE DRAWINGS

FIG. 1 illustrates an embodiment of a system including multiple sensor devices and an example data management system.

FIG. 2 illustrates an embodiment of a system including an example data management system.

FIG. 3 is a simplified block diagram illustrating application of dynamic sampling by a sensor device.

FIG. 4 illustrates remediation of missing data in an example data set.

FIG. 5 illustrates a representation of missing data in a portion of an example data set.

FIG. 6 illustrates use of a tensor generated from an example data set.

FIG. 7 illustrates representations of shared and per-instance variance predictions.

FIGS. 8A-8C are flowcharts illustrating example techniques for managing sensor data utilizing tensor factorization in accordance with at least some embodiments.

FIG. 9 is a block diagram of an exemplary processor in accordance with one embodiment; and

FIG. 10 is a block diagram of an exemplary computing system in accordance with one embodiment.

Like reference numbers and designations in the various drawings indicate like elements.

### DETAILED DESCRIPTION OF EXAMPLE EMBODIMENTS

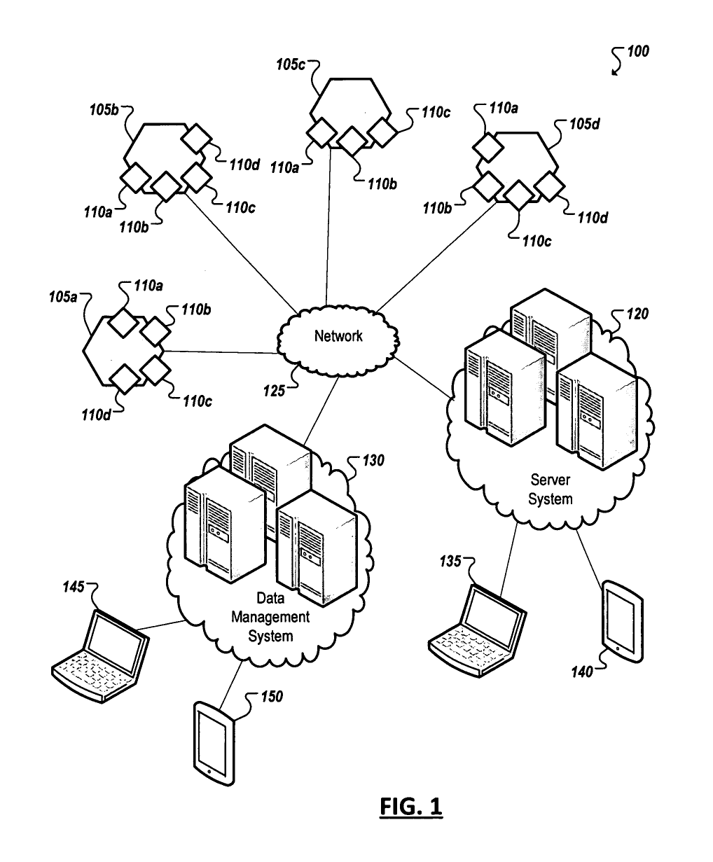

FIG. 1 is a block diagram illustrating a simplified representation of a system 100 that includes one or more sensors devices 105a-d deployed throughout an environment. Each device 105a-d may include one or more instances of various types of sensors (e.g., 110a-d). Sensors are capable of detecting, measuring, and generating sensor data describing characteristics of the environment. For instance, a given sensor (e.g., 110a) may be configured to detect such characteristics as movement, weight, physical contact, temperature, wind, noise, light, computer communications, wireless signals, humidity, the presence of radiation or specific chemical compounds, among several other examples. Indeed, sensors (e.g., 110a-d) as described herein, anticipate the development of a potentially limitless universe of various sensors, each designed to and capable of detecting, and generating corresponding sensor data for, new and known environmental characteristics.

In some implementations, sensor devices 105a-d and their composite sensors (e.g., 110a-d) can be incorporated in and/or embody an Internet of Things (IoT) system. IoT systems can refer to new or improved ad-hoc systems and networks composed of multiple different devices interoperating and synergizing to deliver one or more results or deliverables. Such ad-hoc systems are emerging as more and more products and equipment evolve to become “smart” in that they are controlled or monitored by computing processors and provided with facilities to communicate, through computer-implemented mechanisms, with other computing devices (and products having network communication capabilities). For instance, IoT systems can include networks built from sensors and communication modules integrated in or attached to “things” such as equipment, toys, tools, vehicles, etc. and even living things (e.g., plants, animals, humans, etc.). In some instances, an IoT system can develop organically or unexpectedly, with a collection of sensors monitoring a variety of things and related environments and interconnecting with actuator resources to perform actions based on the sensors' measurements as well as with data analytics systems and/or systems controlling one or more other smart devices to enable various use cases and application, including previously unknown use cases. As such, IoT systems can often be composed of a complex and diverse collection of connected systems, such as sourced or controlled by a varied group of entities and employing varied hardware, operating systems, software applications, and technologies. Facilitating the successful interoperability of such diverse systems is, among other example considerations, an important issue when building or defining an IoT system.

As shown in the example of FIG. 1, multiple sensor devices (e.g., 105a-d) can be provided. A sensor device can be any apparatus that includes one or more sensors (e.g., 110a-d). For instance, a sensor device (e.g., 105a-d) can include such examples as a mobile personal computing device, such as a smart phone or tablet device, a wearable computing device (e.g., a smart watch, smart garment, smart glasses, smart helmet, headset, etc.), and less conventional computer-enhanced products such as smart appliances (e.g., smart televisions, smart refrigerators, etc.), home or building automation devices (e.g., smart heat-ventilation-air-conditioning (HVAC) controllers and sensors, light detection and controls, energy management tools, etc.), and other examples. Some sensor devices can be purpose-built to host sensors, such as a weather sensor device that includes multiple sensors related to weather monitoring (e.g., temperature, wind, humidity sensors, etc.). Some sensors may be statically located, such as a sensor device mounted within a building, on a lamppost or other exterior structure, secured to a floor (e.g., indoor or outdoor), in agricultural facilities and fields, and so on. Other sensors may monitor environmental characteristics of moving environments, such as a sensor provision in the interior or exterior of a vehicle, in-package sensors (e.g., for tracking cargo), wearable sensors worn by active human or animal users, among other examples. Still other sensors may be designed to move within an environment (e.g., autonomously or under the control of a user), such as a sensor device implemented as an aerial, ground-based, or underwater drone, among other examples.

Some sensor devices (e.g., 105a-d) in a collection of the sensor devices, may possess distinct instances of the same type of sensor (e.g., 110a-d). For instance, in the particular example illustrated in FIG. 1, each of the sensor devices 105a-d each include an instance of sensors 110a-c. While sensor devices 105a,b,d further include an instance of sensor 110d, sensor device 105c lacks such a sensor. Further, while one or more sensor devices 105a-d may share the ability (i.e., provided by a respective instance of a particular sensor) to collect the same type of information, the sensor devices' (e.g., 105a-d) respective instances of the common sensor (e.g., 110a-c) may differ, in that they are manufactured or calibrated by different entities, generate different data (e.g., different format, different unit measurements, different sensitivity, etc.), or possess different physical characteristics (e.g., age, wear, operating conditions), among other examples. Accordingly, even instances of the same sensor type (e.g., 110a) provided on multiple different sensor devices (e.g., 105a-d) may operate differently or inconsistently. For instance, a sensor of a particular type (e.g., 110a) provided on a first sensor device (e.g., 105a) may function more reliably than a different sensor of the same type (e.g., 110a) provided on another sensor device (e.g., 105b). As a result, sensor data for a corresponding environmental characteristic may be generated more consistently, frequently, and/or accurately by the sensor on the first sensor device than by the same type of sensor on the second sensor device. Additionally, some sensors of a particular type provided by sensor devices (e.g., 105a-d) may generate data in different unit measurements despite representing a comparable semantic meaning or status. For instance, the data from a temperature sensor may be represented in any one of Celsius, Fahrenheit or Kelvin. Similarly, some sensor devices hosting one or more sensors may function more reliably than other sensor devices, resulting in some sensor devices providing a richer contribution of sensor data than others. Such inconsistencies can be considered inherent in some IoT systems given the diversity of the sensor devices and/or operating conditions involved. However, inconsistencies in the product of sensor data by the collection of sensor devices (e.g., 105a-d) within a system can lead to gaps, or “missing data,” in the aggregate data set generated by the collection of sensor devices, among other example issues.

Continuing with the example of FIG. 1, in some implementations, one or more systems can control, monitor, and/or consumer sensor data generated by a collection of sensor devices (e.g., 105a-d). For instance, a server system (e.g., 120) can serve an application or service derived from the sensor data generated by a collection of sensor devices (e.g., 105a-d). The server system 120 can consume a data set generated by the collection of sensor devices to provide additional utility and insights through analysis of the data set. Such services might include (among potentially limitless alternative examples) air quality analysis based on multiple data points describing air quality characteristics, building security based on multiple data points relating to security, personal health based on multiple data points describing health characteristics of a single or group of human user(s), and so on. Sensor data, consumed by the server system 120, can be delivered to the server system 120 over one or more networks (e.g., 125). Server system 120, in some cases, can provide inputs to other devices (e.g., 105a-d) based on the received sensor data to cause actuators or other functionality on the other devices to perform one or more actions in connection with an IoT application or system.

In some instances, prior to the sensor data being made available for consumption by one or more server systems (e.g., 120) or other devices, sensor data generated by a collection of sensor devices (e.g., 105a-d) can be aggregated and pre-processed by a data management system (e.g., 130). In some cases, a data management system 130 can be implemented separate from, and even independently of, server systems (e.g., 120) or other devices (e.g., 105a-d) that are to use the data sets constructed by the data management system 130. In such cases, data sets (generated from aggregate sensor data) can be delivered or otherwise made accessible to one or more server systems (e.g., 120) over one or more networks (e.g., 125). In other implementations, the functionality of data management system 130 can be integrated with functionality of server system 120, allowing a single system to prepare, analyze, and host services from a collection of sensor data sourced from a set of sensor devices, among other examples. In still other implementations, functionality of the data management system can be distributed among multiple systems, such as the server system, one or more IoT devices (e.g., 105a-d), among other examples.

An example data management system 130 can aggregate sensor data from the collection of sensor devices and perform maintenance tasks on the aggregate data to ready it for consumption by one or more services. For instance, a data management system 130 can process a data set to address the missing data issue introduced above. For example, a data management system 130 can include functionality for determining values for unobserved data points to fill-in holes within a data set developed from the aggregate sensor data. In some cases, missing data can compromise or undermine the utility of the entire data set and any services or applications consuming or otherwise dependent on the data set. In one example, data management system 130 can determine values for missing data based on tensor factorization. For example, in one implementation, data management system 130 can using a tensor factorization model based on spatial coherence, temporal coherence and multi-modal coherence, among other example techniques. Additionally, in instances where the data management system 130 is equipped to determine missing values in sensor data, the system can allow for sensors to deliberately under-sample or under-report data, relying on the data management system's ability to “fill-in” these deliberately created holes in the data. Such under-sampling can be used, for instance, to preserve and prolong battery life and the generally lifespan of the sensor devices, among other example advantages.

One or more networks (e.g., 125) can facilitate communication between sensor devices (e.g., 105a-d) and systems (e.g., 120, 130) that manage and consume data of the sensor devices, including local networks, public networks, wide area networks, broadband cellular networks, the Internet, and the like. Additionally, computing environment 100 can include one or more user devices (e.g., 135, 140, 145, 150) that can allow users to access and interact with one or more of the applications, data, and/or services hosted by one or more systems (e.g., 120, 130) over a network 125, or at least partially local to the user devices (e.g., 145, 150), among other examples.

In general, “servers,” “clients,” “computing devices,” “network elements,” “hosts,” “system-type system entities,” “user devices,” “sensor devices,” and “systems” (e.g., 105a-d, 120, 130, 135, 140, 145, 150, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

The potential promise of IoT systems is based on the cooperation and interoperation of multiple different smart devices and sensors adding the ability to interconnect potentially limitless devices and computer-enhanced products and deliver heretofore unimagined innovations and solutions. IoT systems characteristically contain a significant number of diverse devices, many different architectures, diverse networks, and a variety of different use cases. Such diversity is the strength of IoT systems, but also presents challenges to the management and configuration of such systems.

In addition to having many different architectures, diverse networks, a variety of use cases, and a significant amount of devices with diverse characteristics, many IoT devices may additionally mandate low power constraints across a diverse set of IoT scenarios. Such IoT scenarios can include home automation system, smart city systems, smart farming applications, among other examples. For instance, with home automation an increasing number of IoT devices are being developed and entering the home. It can be impractical to have all of these varied devices connected to the central power source of the home (e.g., light sensors in the ceiling, smoke detectors in the ceiling, motion sensors around the doorway, etc.). Indeed, many IoT devices are being designed not to be reliant on a centralized AC power source, but rather batter power, to ensure the flexibility of their application. However, as a battery-powered device is reliant on the quality of its battery, such devices are prone to unpredictable power outages, as well as diminished performance as the battery capacity runs low, even when the battery is expected to power the device for months, years, etc. Maintaining power within an IoT system employing multiple battery-powered devices can thus place demands on the management of the system. Further, depending upon the number of battery-powered devices in the home (or other environment), an owner or manager of the property may be required to keep tabs on potentially dozens of the devices and bear the costs of repeatedly replacing such batteries. Further, part of the unpredictability of IoT device's power usage is the variability and adaptability of their activity. For instance, IoT devices in a smart city system may include sensor devices that sense such varied attributes as traffic, climate, weather, sunlight, humidity, temperature, stability of power supply and so on and so forth. Further, depending on the placement of each device, the variability of readings may differ dramatically, even between sensors of the same type. This implies that the uncertainty (or certainty) of each sensor reading may differ at different geolocations at different timestamps due to a family of factors. These scenarios all lead to a dilemma between system performance and power efficiency. Specifically, the more frequently readings are sampled at a device, the better accuracy that can be expected in terms of data analytics. However, as readings are sampled more frequently at the device, the higher the use of the device and its power source, thereby potentially diminishing the lifespan of the device and/or its power source.

In one implementation, given the changing variance of each sensor reading, a system can determine per-sensor and/or per data-instance variance to intelligently determine a corresponding sampling rate of a particular sensor during runtime, such that the number of samples is minimized (along with power consumption) while maintaining the integrity of the resulting sensor data set. For instance, the system may adopt a closed-loop client-server architecture for addressing the tradeoff between system performance and power efficiency using interactive sampling monitoring. Missing data within a set can be predictably (and reliably) and determined utilizing techniques such as interpolation, tensor factorization, as well as combinations of the two, such as described below. For instance, Discriminative Probabilistic Tensor Factorization (DPTF) can reliably estimate both missing data values and per instance variance for each sensor reading (either observed or predicted), rather than assuming a shared variance across all readings, as it traditionally done in data analysis systems.

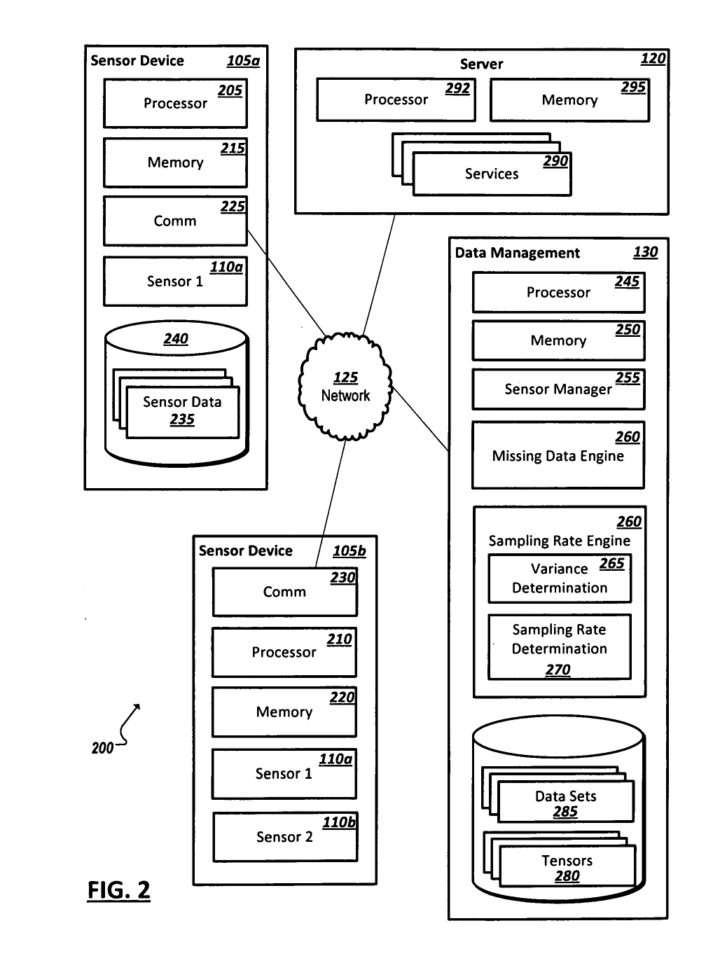

Systems and tools described herein can address at least some of the example issues introduced above. For example, turning to FIG. 2, a simplified block diagram 200 is shown illustrating a system including an example implementation of a data management engine 130 configured to determine missing values in a data set using tensor factorization, determine per-sensor (and, in some cases, per-data instance) variance, and utilize the variance calculations to determine a sufficient sampling rate for each sensor in the system to allow the sensor to deliberately drop data instances at a rate that still allows the data management engine 130 to reliably re-build the dropped data.

In one example, the system can include data management engine 130, a set of sensor devices (e.g., 105a-b), and server 120. The data set can be composed of sensor data (e.g., 235) generated by the collection of sensor devices (e.g., 105a-b). In one example, sensor devices 105a,b can include one or more processor devices 205, 210, one or more memory elements 215, 220, one or more sensors (e.g., 110a-b), and one or more additional components, implemented in hardware and/or software, such as a communications module 225, 230. The communications module 225, 230 can facilitate communication between the sensor device and one or more other devices. For instance, the communications modules 225, 230 can be used to interface with data management engine 130 or server 120 to make sensor data (e.g., 235) generated by the sensor device available to the interfacing system. In some cases, a sensor device (e.g., 105b) can generate sensor data and cause the data to be immediately communicated, or uploaded, to storage of another device or system (e.g., data management system (or “engine”) 130), allowing data storage capabilities of the sensor device to be simplified. In other instances, a sensor device (e.g., 105a) can cache or store the sensor data (e.g., 235) it generates in a data store (e.g., 240). The sensor data 235 in such instances can be made available to other systems (e.g., 120, 130) by allowing access to the contents of the data store 240, with chunks of sensor data being reported or uploaded to the consuming systems (e.g., 120, 130). A communications module 225, 230 can also be used to receive signals from other systems, such as suggested data sampling rates determined by the data management system 130, among other examples. Communications modules can also facilitate additional communications, such as communications with user devices used, for instance, to administer, maintenance, or otherwise provide visibility into the sensor device. In other implementations, sensor devices (e.g., 105a-b) can communicate and interoperate with other sensor devices, and communications module 225, 230 can include functionality to permit communication between sensor devices. Communications modules 225, 230 can facilitate communication using one or more communications technologies, including wired and wireless communications, such as communications over WiFi, Ethernet, near field communications (NFC), Bluetooth, cellular broadband, and other networks (e.g., 125).

In the particular example of FIG. 2, a data management engine 130 can include one or more processor devices 245, one or more memory elements 250, and one or more components, implemented in hardware and/or software, such as a sensor manager 255, missing data engine 260, and sampling rate engine 265, among other examples. A sensor manager 255, in one example, can be configured to maintain records for identifying and monitoring each of the sensor devices (e.g., 105a-b) within a system. The sensor manager 255 can interface with each of the sensor devices to obtain the respective sensor data generated by each sensor devices. As noted above, in some instances, sensor data can be delivered to the sensor manager 255 (e.g., over network 125) as it is generated. In other cases, the sensor manager 255 can query sensor devices to obtain sensor data generated and stored at the sensor devices, among other examples. A sensor manager 255 can aggregate and organize the sensor data obtained from a (potentially diverse) collection of the server devices (e.g., 105a-b). The sensor manager 255 can detect, maintain, or otherwise identify characteristics of each sensor device and can attribute these characteristics, such as sensor type, sensor model, sensor location, etc., to the sensor data generated by the corresponding sensor device. The sensor manager can also manage and control operations of a network of sensor devices to perform a particular sensing or monitoring session. Further, the sensor manager can facilitate communication to the sensors from the data management engine, such as to communicate a suggested data sampling rate to be used by each sensor of each device, among other examples.

In one example, a data management engine 130 can include a missing data engine 260 embodied in software and/or hardware logic to determine values for missing data in the sensor data collected from each of and/or the collection of sensor devices 105a-b. For instance, in one implementation, missing data determination engine 260 can include tensor generation logic, tensor factorization logic, and/or interpolation logic, among other components implemented in hardware and/or software. In one example, the missing data determination engine 260 can process data sets or streams from each of the sensor instances (e.g., 110a,b) possessing missing data to determine one or more n-dimensional tensors 280 for the data. In some implementations, the data management engine 130 can utilize tensor factorization using corresponding tensors 280 to determine values for one or more missing data values in data received from the sensor devices. The missing data determination engine 260 can also utilize interpolation, in some instances, to assist in deriving missing data. For instance, interpolation can be used in combination with tensor factorization to derive missing data values in a data stream or set. In some cases missing data determination engine 260 can derive predicted values for all missing data in a particular data set or stream. In such instances, the data set can be “completed” and made available for further processing (e.g., in connection with services 290 provided by a server 120 or one or more other sensor devices). In other instances, tensor factorization can determine most but not all of the values for the missing data in a data set (e.g., from the corresponding tensor 280). In such instances, interpolation logic 275 can be used to determine further missing data values. Specifically, tensor factorization engine 270 can complete all missing values within the tensor representation. However, in some cases, values not comprehended within the tensor representation may be of interest (e.g., corresponding to geolocations without a particular deployed sensor type, instances of time without any observed sensor values, etc.). The interpolation logic 275 can operate on the partially completed data set 285 following tensor factorization learning. In other words, interpolation performed by interpolation engine 275 can be performed on the improved data set composed of both the originally-observed data values and the synthetically-generated missing data values (i.e., from tensor factorization). Interpolation can be used to address any missing data values remaining following tensor factorization to complete the data set 285 and make it ready for further processing.

A data management system 130 may additionally include a sampling rate management engine 260. The sampling rate management engine can be executable to determine the variance of data values generated by each of the sensors (e.g., using variance determination logic 265). Indeed, in some implementations, variance determination logic 265 can be configured to determine the variance on a per-sensor basis, as well as a per-instance (or per-data point) basis. Accordingly, sampling rate engine 260 can be used to determine the variability of the variance of each of the sensor instances (e.g., 110a,b) of the devices (e.g., 105a-c) to which it is communicatively coupled (e.g., over network 125). The variance measures determined by the variance determination logic 265 can be based on the accuracy, or degree of error, of the predicted missing data values derived by the missing data engine 260 for the same sensors. Indeed, tensor factorization can be utilized to derive the estimate variance measures for each of the data streams having missing data values. These variance measures can then be used (e.g., by sampling rate determination logic 270) to determine an optimized or minimized sampling rate, which could be communicated to and applied at each sensor (e.g., 110a,b) to allow the sensors to drop a portion of its data in an effort to preserve power and other resources of the sensor.

In one implementation, the system can be embodied as a non-interactive client-server system, in which a client (e.g., sensor device 105a,b) may randomly drop data points for power efficiency or other purposes while the server (e.g., the data management system) utilizing missing data determination logic to reliably reconstruct the full spectrum of the data. In an interactive client-server system (with bi-directional communication), the client (e.g., sensor device) is instructed explicitly by the server (e.g., data management system 130) with a specific determined probability, or rate (e.g., determined by sampling rate determination logic 270) at which the client can drop data while still allowing the missing data determination logic (e.g., 260) of the server (e.g., 130) to reliably reconstruct the full spectrum of the data (e.g., by reliably determining the values of the data dropped by the client).

To determine the rate at which a sensor device can drop data, the data management system 130 can determined, for each sensor (e.g., 110a,b), the variability of variance of data values generated by the particular sensor instance. In other words, the statistical variance (or uncertainty, confidence) can be determined at a per instance (i.e., per data point) level, such that at a certain location at a certain timestamp from a certain sensor type, variance determination logic (e.g., using discriminative probabilistic tensor factorization) can determine the variance of that corresponding data point (whether reported to or predicted by the missing data determination logic).

Accordingly, data management system 130 can interoperate with sensor devices (e.g., 105a,b) to provide an end-to-end architecture for interactive sampling monitoring, and in effect address low power constraints (among other issues), to allow sensors to randomly, opportunistically, or intelligently drop sensor data of any or all sensors, while the data management system 130 reconstructs the complete data from the intermittent (incomplete) data (e.g., to build data sets 285) and estimates the variance (error) for each data point (either observed or predicted). Further, the data management system 130 can periodically instruct (e.g., at a per data instant or longer frequency) one or more of the sensors (e.g., 110a,b) to dynamically adjust their respective sampling rate during runtime based on the corresponding changes in variance determined by the data management system 130.

A server system 120 can be provided to consume completed data sets 285 prepared by data management system 130. In one example, the server 120 can include one or more processor devices 292, one or more memory elements 295, and code to be executed to provide one or more software services or applications (collectively 290). The services 290 can perform data analytics on a data set 285 to generate one or more outcomes in connection with the service 290. In some cases, the service 290 can operate upon a data set 285 or a result derived by the data management system from the data set 285 to derive results reporting conditions or events based on information in the data set 285. In some examples, a service 290 can further use these results to trigger an alert or other event. For instance, the service 290 can send a signal to a computing device (such as another IoT device possessing an actuator) based on an outcome determined from the completed data set 285 to cause the computing device to perform an action relating to the event. Indeed, in some cases, other devices can host a service or an actuator that can consume data or data sets prepared by the data management system 130. In some cases, the service 290 can cause additional functionality provided on or in connection with a particular sensor device to perform a particular action in response to the event, among other examples.

While FIG. 2 illustrated one example of a system including an example data management engine, it should be appreciated that the system shown in FIG. 2 is provided as a non-limiting example. Indeed, a variety of alternative implementations can likewise apply the general principles introduced in FIG. 2 (and elsewhere within the Specification). For instance, functionality of the server and data management engine can be combined. In some instances, the data management engine may include or be provided in connection with one of the sensor devices in a collection of sensor devices (e.g., with the sensor device having data management logic serving as the “master” of the collection). In some instances, functionality of one or both of the server and data management engine can be implemented at least in part by one or more of the sensor devices (and potentially also a remote centralized server system). Indeed, in one example, the data management engine can be implemented by pooling processing resources of a plurality of the sensor devices or other devices. In yet another alternative example, the varied components of a data management engine 130 can be provided by multiple different systems hosted by multiple different host computers (e.g., rather than on a single device or system). Further, while the sensor devices represented in FIGS. 1-2 are shown with varied sensing capabilities, in some implementations, each of the sensor devices may each be equipped with matching sensing capabilities, among other alternative examples.

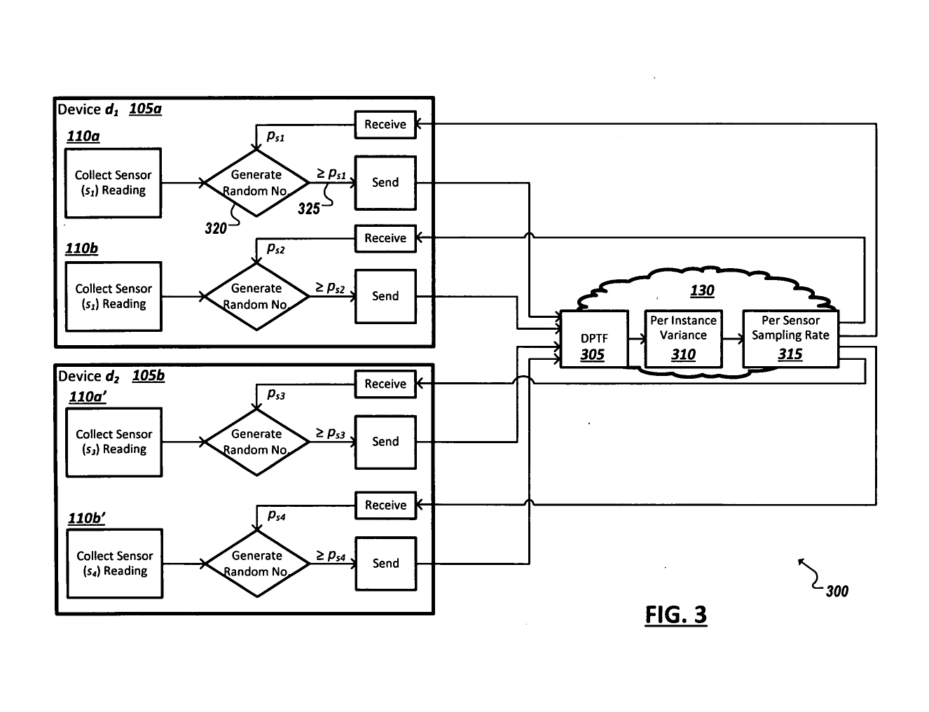

Turning to the example of FIG. 3, an implementation of a closed-loop architecture 300 of an end-to-end IoT sensor data management system is illustrated. The architecture can include two or more sensor devices (e.g., 105a,b) each with one or more sensors (e.g., 110a, 110a′, 110b, 110b′) coupled to an interface of a data management system 130. The data management system can utilize per instance variance estimation (based on sensor data reported by the sensors) to generate feedback regarding the sampling rates to be adopted at each sensor (e.g., 110a, 110a′, 110b, 110b′).

As noted above, in some implementations, one or more sensor devices (e.g., 105a,b) in a system may include heterogeneous sensors (e.g., 110a, 110a′, 110b, 110b′). Upon data collection of sensor sⱼ at each time step t, the sensor device dₜ uses a sampling probability p_{d}_{ᵢ}_{,s}_{ⱼ} to determine whether or not to take a data reading, or alternatively, transmit a data reading to the data management (in either instance “dropping” the reading). The probability p_{d}_{ᵢ}_{,s}_{ⱼ} can be determined from per instance variance σ_{d}_{ᵢ}ₛ_{ⱼ}_{,t}, ∀_{i,j,t}, which is calculated utilizing per instance variance estimation techniques such as described herein. The probability p_{d}_{ᵢ}_{,s}_{ⱼ} is initialized locally with a predetermined value and may then be updated on the fly by the data management system 130.

The data management system 130 may include computational logic to determine per instance variance estimation, for instance, using discriminative probabilistic tensor factorization (DPTF) (at 305) to predict variance (at 310) in a per instance (data point) manner (i.e., per device/per sensor/per time step instance). The per instance variance can then be used to generate a sampling probability (or rate) (at 315) for each sensor (e.g., 110a, 110a′, 110b, 110b′) on each device (e.g., 105a,b). The updated sampling probability (e.g., generated at 315) can then be sent back to the corresponding device (e.g., 105a,b). Upon successful receipt of the updated sampling probability, the device can determine whether to adopt the new sampling probability, and if adopted, can use the updated probability to determine, for the next or other subsequent data readings) whether or not to take or transmit the reading data back to the data management system.

In one example implementation, such as shown in the simplified block diagram 300 of FIG. 3, a sensor (e.g., 110a) on a device (e.g., 105a) obtains a data reading and determines whether a sampling probability is available for the sensor (e.g., 110a). If so, the device can apply the sampling probability to the sensor to determine whether to drop or send the data reading to the data management system 130. If no sampling probability has been received or registered, the sensor can perform unrestrained, sending each and every data reading to the data management system 130.

If the device (e.g., 105a) determines that a sampling probability applies to a given one of its sensors (e.g., 110a), before sending out (or in other implementations, even taking the reading), the device (e.g., 105a) can generate a random number (at 320) (e.g., with a value from 0-1) corresponding to the data instance and determine (at 325) whether the random number is greater or less than the identified sampling probability (e.g., sampling probability pₛ₁ also with a value ranging from 0-1). In instances where the random number is greater than or equal to (or, alternatively, simply greater than) the sampling probability pₛ₁, the device (e.g., 105a) can determine to send the corresponding data reading instance to the data management system 130. However, in instances where the device determines that the random number is less than (or, alternatively, less than or equal to) the sampling probability pₛ₁, the device (e.g., 105a) can determine to drop the corresponding data reading instance, such that the data management system 130 never receives the reading and, instead, generates a replacement value for the dropped reading using missing data determination logic (e.g., utilizing discriminative probabilistic tensor factorization 305). In cases where the device (e.g., 105a) drops the data reading instance by cancelling the sending of the data, the device can store the dropped data reading in local memory (e.g., for later access in the event of an error at the data management system 130 or to perform quality control of missing data or variance estimate determined by the data management system 130, among other examples). In other instances, the device (e.g., 105a) can simply dispose of the dropped data.

Upon receiving an instance of reading data from a sensor (e.g., 110a), the data management system 130 can reconstruct missing data along with per instance variance, for instance, using discriminative probabilistic tensor factorization. In some cases, a tensor can be generated and user on a per-sensor device basis (e.g., with different tensors generated and used for each sensor), while in other instances, a single tensor can be developed for a collection of multiple sensors, among other implementations. The data management system 130 then uses the corresponding sensor's (e.g., 110a) per instance variance over time to determine the corresponding suggested sampling rate or sampling probability pₛ₁ and thereby sampling rate (e.g., the probability multiplied by the sensor's native sampling frequency). For instance, a function can be determined utilizing machine learning techniques to determine the updated sampling rate corresponding to the latest per-instance variance determined for the sensor. Alternatively, control loop feedback (e.g., using a proportional-integral-derivative (PID) controller) can be utilized to iteratively derive and update the sampling rate from the history or per-instance variances determined for the sensor, among other examples. The newly determined sampling rate can then be returned, or fed back, to the corresponding device for application at the sensor within the closed loop of the architecture. Similar data sampling loops can be determined and applied for each of the sensors (e.g., (e.g., 110a, 110a′, 110b, 110b′)) coupled to the data management system by one or more networks. By determining the lowest sampling rate that can be applied at each device while preserving the data management system's ability to accurately reconstruct the deliberately dropped sensor data readings, the power and usage demands of the devices can be reduced, prolonging their lifespans.

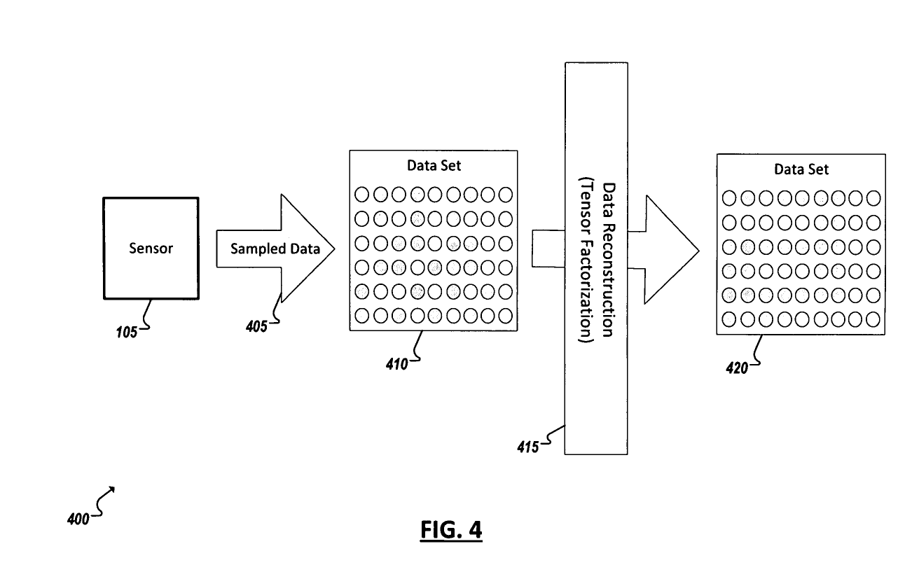

Turning to FIG. 4, a simplified block diagram 400 is presented showing the reconstruction of data within a closed-loop architecture of an end-to-end IoT sensor data management system, similar to other examples illustrated and discussed herein. One of a set of sensors 105 in the environment can apply (at 405) a sampling rate to the generation or transmission of its sensor data such that only a sampled subset 410 of all potential sensor data generated by the sensor 105 is delivered to the data management system. The data management system can apply data reconstruction 415 to derive estimated values (e.g., using discriminative probabilistic tensor factorization techniques) for all of the sensor reading data points that were dropped during the sampling to build a complete data set 420.

As noted above, discriminative probabilistic tensor factorization can be utilized both to reconstruct missing data values as well as derive per-instance variance for data generated by IoT sensors. In one example, to determine a tensor for a data stream or set, a 3-dimensional tensor can be defined by determining spatial coherence, temporal coherence, and multi-modal coherence of the data set. The tensor can represent the collaborative relationships between spatial coherence, temporal coherence, and multi-modal coherence. Coherence may or may not imply continuity. Data interpolation, on the other hand, can assume continuity while tensor factorization learns coherence, which may not be continuous in any sense. Spatial coherence can describes the correlation between data as measured at different points in physical space, either lateral or longitudinal. Temporal coherence can describe the correlation between data at various instances of time. Multi-modal coherence can describe the correlation between data collected from various heterogeneous sensors. The tensor can be generated from these coherences and can represent the broader data set, including unknown or missing values, with tensor factorization being used to predict the missing values.

Traditional techniques for determining missing data rely on data models based on one or more functions, f, each function being used to determine a respective value, y, from one or more respective variables, or features, x. In such models, the determination of the value y is dependent on x and the corresponding feature x must, therefore, be present for whichever data point (e.g., of y) we are to predict. In other words, features can be considered additional information that correlates with a particular set of data values. For example, in air quality inference, features may include population, temperature, weekday or weekend, humidity, climate, etc. upon which one or more other values are defined to depend. However, when a feature value is not available across space and time, values of other data dependent on the feature are not available. Consistent availability of features is not always comprehensive or available, resulting in errors when features are relied upon in interpolation of various data. Systems providing missing data tensor factorization based on spatio-temporal coherence with multi-modality can be performed without the use of features (although features can be used to supplement the power of the solution).

Coherence may not assume continuity in space and/or time, but instead learns collaboratively the coherence across space, time, and multimodal sensors automatically. Note that tensor representation does not assume continuity; namely, the results are the same even if, hyperplanes, e.g., planes in a 3D tensor, are shuffled beforehand.

While interpolation generally takes into account spatial continuity and temporal continuity, a data management engine may determine (or predict or infer) data values of multi-modality jointly and collaboratively using tensor factorization. As an example, in the case of a data set representing air quality samples, coarse dust particles (PM10) and fine particles (PM2.5) may or may not be correlated depending on spatial coherence, temporal coherence and other environmental factors. However, tensor factorization can learn their correlation, if any, without additional information or features (such as used by supervised learning techniques like support vector machines (SVMs) which mandate features), among other examples.

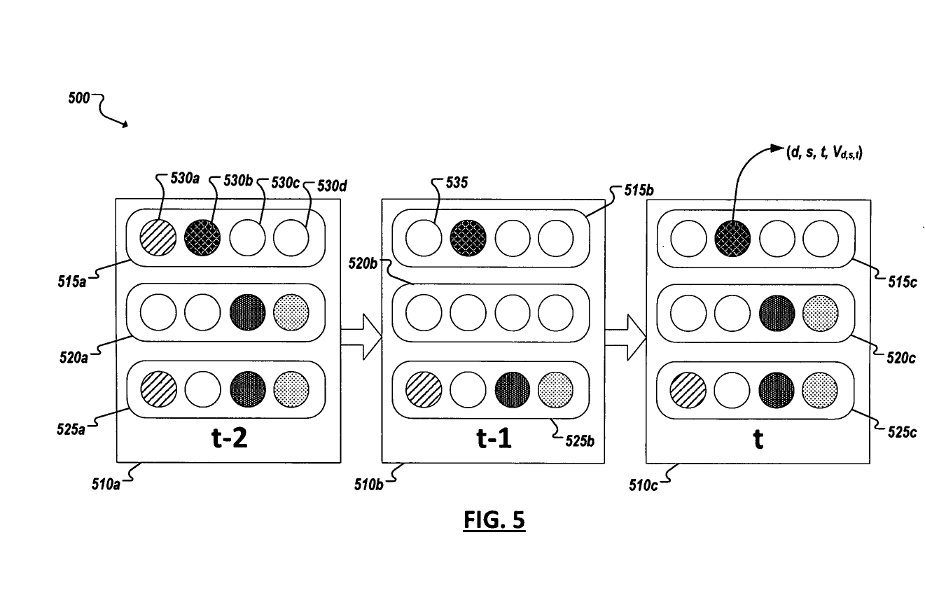

Turning to FIG. 5, a simplified block diagram 500 is shown illustrating a representation of a data set generated by three example sensor devices and including missing data. FIG. 5 represents portions 510a, 510b, 510c of a data set collected at three instances of time (i.e., t-2, t-1, and t). At each instance of time, three distinct sensor devices at three distinct physical locations (represented by groupings 515a-c, 520a-c, 525a-c)can attempt to provide data using four different sensors, or modalities (e.g., 530a-d). Accordingly, the block diagram 500 represents instances of missing data within a data set. For instance, element 530a is represented as filled to indicate that data was returned by a first sensor type located spatially at a first sensor device at time t-2. Likewise, as shown by element 530b, data was returned by a different second sensor located at the first sensor device at time t-2. However, data was missing from a third and fourth sensor (as shown in the empty elements 530c-d) at the first sensor device at time t-2. Further illustrated in FIG. 5, in one example, while data was successfully generated by a first sensor of a first sensor device at time t-2 (as shown by 530a), data for that same sensor was missing at time t-1 (as shown by 535). Indeed, as shown in element 520b, no sensor located at a second sensor device generated data at time t-1, while three out of four sensors (e.g., sensors of the first, third, and fourth types) of the third sensor device generate data at time t-1. A sensor device may fail to generate data for a particular modality at a particular instance of time for a variety reasons, including malfunction of the sensor, malfunction of the sensor device (e.g., a communication or processing malfunction), power loss, etc. In some instances, a sensor device may simply lack a sensor for a particular modality. As an example, in FIG. 5, data generated by a second sensor device (represented by 520a-c) may never include data of the first and second sensor types. In some examples, this may be due to the second sensor device not having sensors of the first and second types, among other potential causes.

As illustrated in FIG. 5, each data value can have at least three characteristics: a spatial location (discernable from the location of the sensor device hosting the sensor responsible for generating the data value), a time stamp, and a modality (e.g., the type of sensor, or how the data was obtained). Accordingly, device location, sensor type, and time stamp can be denoted as d, s, t, respectively, with V_{d,s,t} referring to the value for a data point at (d, s, t). Thus the value of each data point can be represented by (d, s, t, V_{d,s,t}), as shown in FIG. 5. For missing data, the corresponding value V_{d,s,t} will be empty.

In one example, values of missing data (e.g., illustrated in FIG. 5) can be inferred by normalization parameters of each sensor and learning latent factors to model the latent information of each device (or spatial location) (d), sensor (or modality) (s), timestamp (t) data point using tensor factorization. Any missing data remaining from spatial or temporal gaps in the data set, not addressable through tensor factorization can then be addressed using interpolation based on prediction values to compensate sparsity of training data. Interpolation can be used, for instance, to infer missing data at locations or instances of time where no data (of any modality) is collected.

A multi-modal data set can be pre-processed through normalization to address variations in the value ranges of different types of data generated by the different sensors. In one example, normalization can be formulated according to:

$${V}_{d , s , t}^{′} = \frac{{V}_{d , s , t} - {μ}_{s}}{{σ}_{s}} \qquad ( 1 )$$

Where μₛ denotes the mean and σₛ denotes the standard deviation of all observed values with a sensor type, or modality, s. In some cases, normalization can be optional.

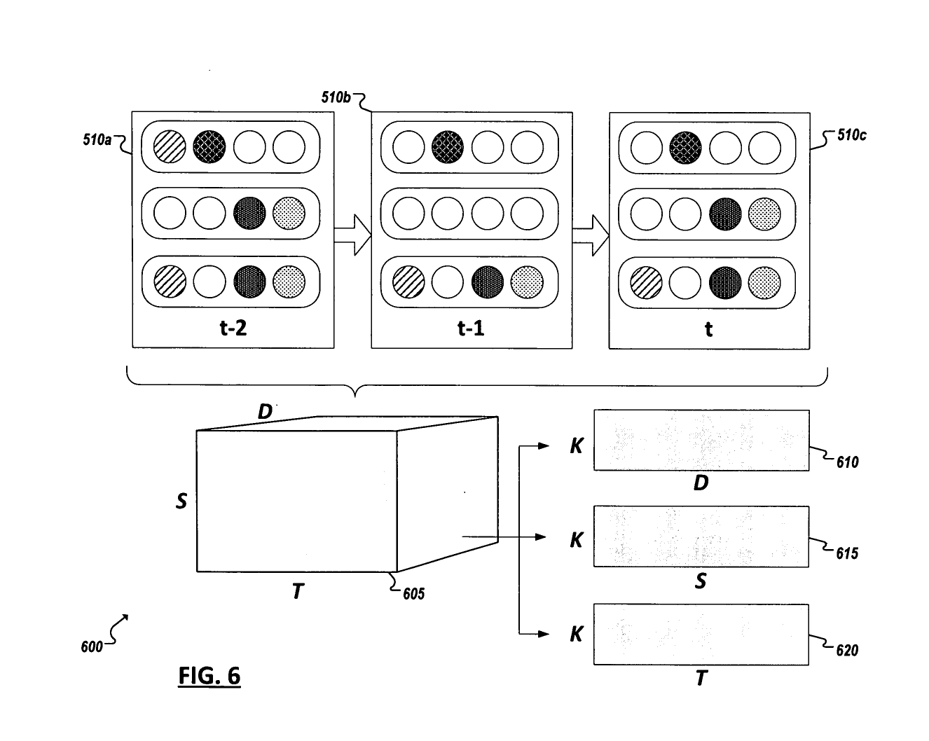

Proceeding with the determination of missing data values in a data set, latent factors can be constructed and learned. Turning to FIG. 6, a simplified block diagram 600 is shown representing high level concepts of missing data tensor factorization. Raw data (e.g., from 510a-c) can be transformed into a tensor V (605) according to the three dimensions of device location (spatiality) D, sensor type (modality) S, and timestamp T. Thus the tensor V (605) can have dimension dxsxt and include the missing values from the raw data. Tensor factorization can be used to decompose V into a set of low rank matrices (e.g., 610, 615, 620) D, S, T, so that:

V_{d,s,t}=D_{d}·Sₛ·Tₜ, where D ∈R^{dk}, S ∈R^{sk},T ∈R^{tk}

Tensor factorization can address multi-modal missing data by generating highly accurate predictive values for at least a portion of the missing data. A tensor V with missing data can be decomposed into latent factors D, S, T.

In the absence of a feature for each data point (d, s, t), standard supervised machine learning techniques fail to learn a feature-to-value mapping. Tensor factorization, however, can be used to model data and infer its low rank hidden structure, or latent factors. Assuming there are latent factors for all device locations, sensor types and at all timestamps, the missing data can be modeled by learning latent factors from the (present) observed data. As a result, these latent factors can be utilized to make prediction and further optimizations. Given arbitrary latent factors of dimension k for each device location, sensor type and timestamp, predictions for a (missing) data point (d, s, t) can be determined according to the following formula:

V̅_{d,s,t}=ΞₖD_{d,k}*S_{s,k}*T_{t,k} (2)

Equations (1) and (2) can be used in combination to derive an objective function with latent factors. In some cases, using the mean-squared error between Equation (1) and (2) can be used to develop optimized training data, however, this approach can potentially over-fit the training data and yield suboptimal generalization results. Accordingly, in some implementations, a regularization term can be further applied to the objective function and applied to the latent factors, D, S, and T, to regularize the complexity of the model. For instance, an L2 regularization term, i.e. the Frobenius norm of latent factors, can be adopted to ensure differentiability through the objective function. As an example, regularization can be combined with normalization (e.g., Equation (1)) to yield:

Ξ_{observed(d,s,t)}(V̅_{d,s,t}−V′_{d,s,t})²+λ(∥D∥₂²+∥S∥₂²+∥T∥₂²) (3)

In Equation (3), λ is a value selected to represent a tradeoff between minimizing prediction error and complexity control.

To optimize Equation (3), stochastic gradient descent (SGD) can be used. For instance, an observed data point can be selected at random and can be optimized using the gradient of the objective function (3). For instance, an SGD training algorithm for latent factors can be embodied by as:

INPUT: a set of data points (d, s, t) with their value V_{d,s,t},
iteration N, latent dimension K, and learning rate α
OUTPUT: trained latent factors
Randomly initialize D, S, T with dimension (# of devices, K), (# of
sensors, K), (# of timestamps, K)
For i in 1:N {

For (d, s, t) in data set {

Σₑᵣᵣₒᵣ₌ₖ D_{d,k} * S_{s,k} * T_{t,k} − V′_{d,s,t}
for k in 1:K {

D_{d,k}−= α(error * S_{s,k} * T_{t,k} + λD_{d,k})
S_{s,k}−= α(error * D_{d,k} * T_{t,k} + λS_{s,k})
T_{t,k}−= α(error * S_{s,k} * D_{d,k} + λT_{t,k})

}

}

}
Return D, S, T

Resulting latent factors, D, S, T, can be regarded as a factorization of the original, observed dataset. For instance, as represented in FIG. 6, given that the original dataset is formulated as a mode-3 tensor 605, the sensor data can be factorized into three disjoint low-rank representations (e.g., 610, 615, 620), for instance, using PARAFAC factorization or another tensor decomposition technique. In some cases, the low-rank property can also suggest better generalization to unknown data from limited search space for optimizing the model, among other examples.

Through tensor factorization, missing data entries within the tensor can be recovered. However, in some cases, missing data values may lie outside the tensor in a multi-modal data set. For instance, if there are no values at all for a particular “plane” in the tensor, the corresponding latent factors do not exist (and effectively, neither does this plane within the tensor). In one example, planes of missing data in a tensor 605 can exist when there are no sensor readings at all devices at a particular time stamp. Additionally, planes of missing data in tensor 605 can result when there are no sensor readings at any time at a particular device location. Planes of missing data can be identified (before or after generation of the tensor 605) to trigger an interpolation step on the result of the tensor factorization. Bridging a spatial gap (e.g., a tensor plane) can be accomplished through interpolation to approximate the values for an unobserved device d′ as follows:

$${\hat{v}}_{{d}^{′} , s , t} = \frac{{\sum }_{d != {d}^{′}} \frac{\overline{v}}{distance ( d , {d}^{′} )}}{{\sum }_{d != {d}^{′}} \frac{1}{distance ( d , {d}^{′} )}} \qquad ( 4 )$$

To bridge a gap in time, d′ can be generalized, for instance, by learning an objective function that minimizes the Euclidean distance between nearby time latent factors, among other example implementations.

In summary, a multi-modal data set composed of sensor data collected from a plurality of sensors on a plurality of sensor devices can be composed of observed data values as generated by the sensor devices. A subset of the data points in the original data set can be missing (e.g., due to sensor failure or malfunction, environmental anomalies, accidental or deliberate dropping of values, etc.). A tensor can be developed based on the original data set and serve as the basis of tensor factorization. From the tensor factorization, values for some or all of the originally missing data points can be determined, or predicted. In cases where the tensor factorization succeeds in determining values for each of the missing data points, the data set can be considered completed and made available for further processing and analysis. This may result when no empty “planes” are present in the tensor. When empty data point values remain following the tensor factorization an additional interpolation process can be performed in some instances on the updated data set (i.e., that includes the results of the tensor factorization but still some missing data values) to predict values for any remaining missing data points and produce the completed data set.

In some implementations, per instance variance estimation can be formulated in combination with a missing data reconstruction mechanism (e.g., described herein), as the variance calculation is intimately related to reconstruction error. In other words, the noisier a data point (or sensor) is, the less likely the missing data determination logic will be able to accurately reconstruct its values, resulting in a higher reconstruction error than other data points. Such as described herein, tensor factorization can be utilized to implement IoT multi-modal sensor missing data completion. Tensor factorization involves decomposition of a mode-n tensor (n-dimensional tensor) into n disjoint matrices, such as shown in FIG. 6. Each matrix (e.g., 610, 615, 620) represents a specific aspect (dimension) of data. For example, in an IoT scenario, there may be a device dimension, a sensor dimension, and a time, or timestamp, dimension. In such an example, the collection of each data point within the matrix (at device, sensor, timestamp) may result in a mode-3 tensor. Consequently, the factorization is done by decomposing the data tensor into device matrix, sensor matrix, and timestamp matrix through reconstruction as depicted in FIG. 6.

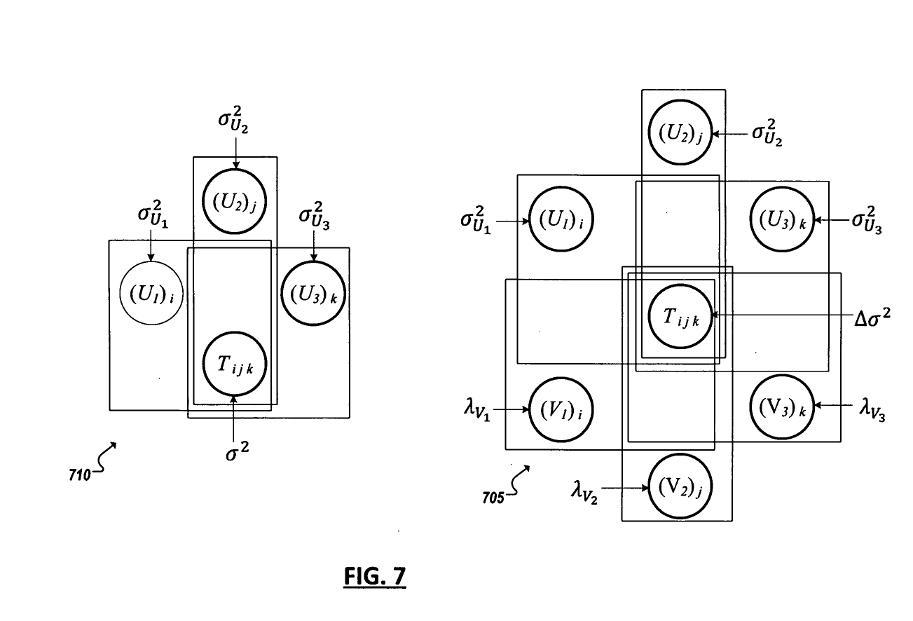

With Discriminative Probabilistic Tensor Factorization (DPTF), each data point instance can be modeled as an independent Gaussian distribution. To derive per instance variance; the unobserved per instance variance can be learned from a posterior distribution of data. For instance, tensor factorization for mean (i.e., missing data prediction) and variance can be performed simultaneously, with the output of each being used to formulate a posterior distribution for the data. The graphical model shown in FIG. 7 represents the difference between a DPTF model 705 for per-instance variance and a conventional tensor factorization 710 where variance is assumed to be shared. To formulate the posterior distribution for the data, as represented in FIG. 7, the prior and likelihood distributions are formulated and the posterior distribution is learned as the objective function. As an example, suppose a mode-n tensor T, factorized matrices U₁, . . . , Uₙ for mean, and factorized matrices V₁, . . . , Vₙ for variance. In such an example, the formulation of posterior distribution with discriminative variance upon data is defined as the multiplication among Equations 7, 8, 9, which is further derived from Equations 5 and 6, set forth below. In one example, to learn the posterior distribution, a gradient descent optimization technique can be applied, among other alternative techniques.

$$\begin{matrix}{\overline{T}}_{{i}_{1} … {i}_{n}} = {( {U}_{1} )}_{{i}_{1}} ° … {° ( {U}_{n} )}_{{i}_{n}} \\ = {\sum }_{d = 1}^{D} {( {U}_{1} )}_{{i}_{1} d} \times … \times {( {U}_{n} )}_{{i}_{n} d}\end{matrix}$$

Equation 5: Estimation of mean (missing data prediction)

Y̅ᵢ_{₁}_{. . . i}_{ₙ}=(V₁)ᵢ_{₁}°. . . °(Vₙ)ᵢ_{ₙ}

Equation 6: Estimation of variance

$$p ( {U}_{u} \vert {σ}_{{U}_{n}}^{2} ) = {\prod }_{i = 1}^{{N}_{u}} N ( {( {U}_{u} )}_{i} \vert 0 , {σ}_{{U}_{u}}^{2} I ) , ∀ u$$

Equation 7: Prior distribution of mean latent factors

$$p ( {V}_{v} \vert {λ}_{{V}_{v}}^{2} ) = {\prod }_{j = 1}^{{N}_{v}} EXP ( {( {V}_{v} )}_{i} \vert {λ}_{{V}_{v}}^{2} I ) , ∀ v$$

Equation 8: Prior distribution of variance latent variables

$$p ( T \vert {U}_{1} , … , {U}_{n} , {V}_{1} , … , {V}_{n} ) = {\prod }_{{i}_{1} = 1}^{{N}_{1}} … {\prod }_{{i}_{n} = 1}^{{N}_{n}} N ( {T}_{{i}_{1} … {i}_{n}} \vert {\overline{T}}_{{i}_{1}} {… }_{{i}_{n}} , {\overline{Y}}_{{i}_{1}} {… }_{{i}_{n}} )$$

Equation 9: Likelihood distribution over latent variables.

In some implementations, tests can be conducted to verify, assess, or improve the function of the data management system. For instance, to verify the effectiveness of Discriminative Probabilistic Tensor Factorization (DPTF) logic of a data management system, a correlation can be calculated between predicted variance and the mean-squared-error of the missing data prediction. The mean-squared-error (MSE) can be first defined by the error of a missing data completion problem. That is, all observed data can be separated into disjoint training and testing data. The DPTF logic of the data management system can then be trained on the training data to capture instance wise distribution on the dataset. Thereafter, the expectation (mean) of instance-wise distribution can be used as its prediction, and MSE can be measured between the prediction and ground truth holdout data (e.g., the actual observed data as generated by the sensor and transmitted to the server). The interpretation of MSE can be regarded as the actual fitting level on the unobserved part of our model, while the variance can be regarded as the fitting level from the perspective of our model. Hence, the correlation between variance and MSE can be used to evaluate the feasibility of instance wise variance measurement. Baselines can be generated for use in the comparisons. Such baselines can include, for instance, random predictions, device information baselines (e.g., for a data point (device, sensor, timestamp), inverse of the number of records for the device in the training data can be used its prediction, based on the notion that more information available may imply more accurate prediction, sensor information baselines (e.g., similar to device information baselines, but defined as the inverse of the number of records for the sensor), and time information baselines (e.g., also to device information baselines, but defined as the inverse of the number of records for the timestamp), among other potential baselines.

While some of the systems and solution described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

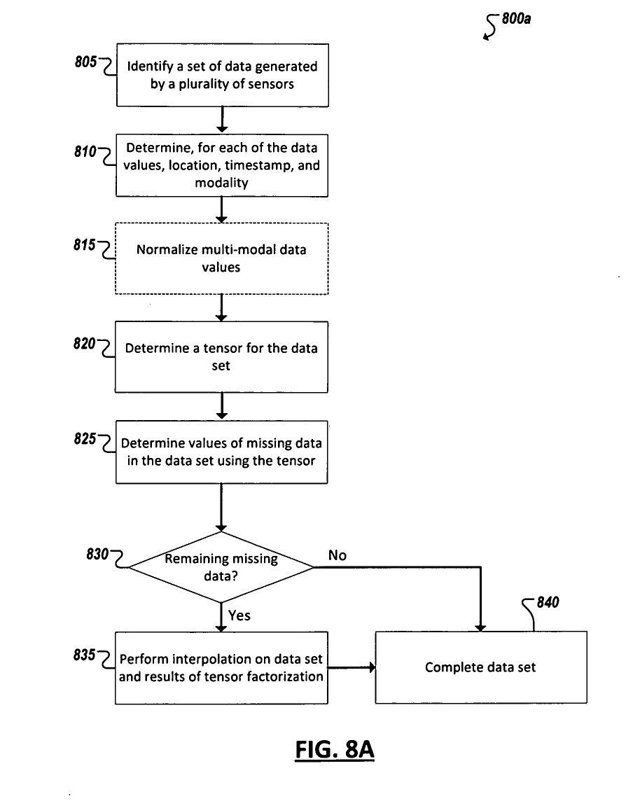

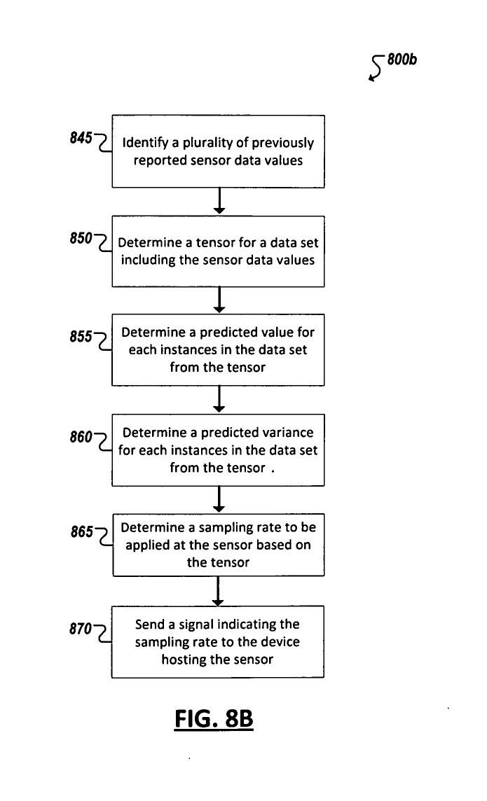

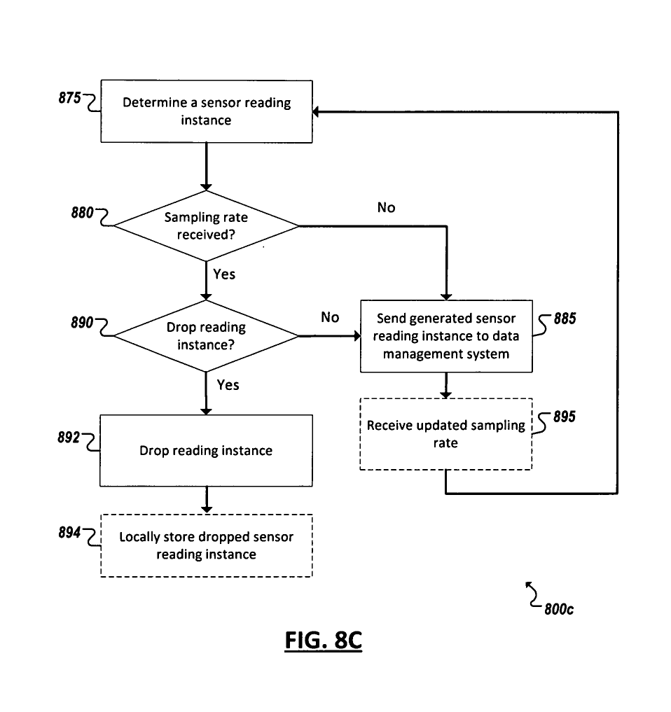

FIG. 8A is a simplified flowchart 800a illustrating an example technique for finding values of missing data. For instance, a set of sensor data can be identified 805 generated by a plurality of sensors located in different spatial locations within an environment. The plurality of sensors can include multiple different types of sensors and corresponding different types of sensor data can be included in the set of sensor data. A plurality of potential data points can exist, with some of the data points missing in the set of sensor data. For each data point (and corresponding sensor data value), a corresponding spatial location, timestamp, and modality can be determined 810. Location, timestamp, and modality can also be determined for data points with missing values. In some cases, spatial location, timestamp, and modality can be determined 810 from information included in the sensor data. For instance, sensor data can be reported by a sensor device together and include a sensor device or sensor identifier. From the sensor device identifier, attributes of the sensor data can be determined, such as the type of sensor(s) and location of the sensor device. Sensor data can also include a timestamp indicating when each data point was collected. The sensor data can be multi-modal and an optional data normalization process may be (optionally) performed 815 to normalize data values of different types within the data set. A three-dimensional tensor can be determined 820 from the data set, the dimensions corresponding to the data points' respective spatial locations, timestamps, and modalities. Values of the missing data in the set can be determined 825 or predicted from the tensor, for instance, using tensor factorization. For instance, latent factors can be determined from which missing data values can be inferred. The data set can then be updated to reflect the missing data values determined using the tensor together with the originally observed data point values. If missing data values remain (at 830) an interpolation step 835 can be performed on the updated data set to complete 840 the data set (and resolve any remaining missing data values). Any suitable interpolation technique can be applied. In other cases, all missing data values in the data set can be determined from the tensor and no missing data (at 830) may remain. Accordingly, in such cases, the data set can be completed 840 following completion of tensor factorization that determines values for all missing data values in a set.

FIG. 8B is a simplified flowchart 800b is shown illustrating an example technique for generating (e.g., at a data management system) a sampling rate to apply at a sensor based on a corresponding predicted per-instance variance determined through tensor factorization. A plurality of previously reported sensor data values can be identified 845, reported by one or more sensors. An n-dimensional tensor for a data set can be determined 850 from the plurality of previously reported sensor data values. Values can be predicted 855 for all of the instances of the data set using the tensor. Indeed, in the event of missing data within the data set, these missing values can be predicted to stand-in for the actual values. Such missing data can include data instances that were dropped in accordance with a sampling rate applied at the corresponding sensor. A predicted variance can be determined 860 for each instance in the data set from the same tensor. From the corresponding predicted per-instance variance, a sampling rate can be determined 865 for a particular sensor. The sampling rate, when applied at the sensor, can cause the sensor to readings at a rate corresponding to the probability that values of these dropped readings can be reliably predicted from the tensor. The determined sampling rate can be communicated to the sensor by sending 870 a signal indicating the sampling rate to a device hosting the sensor. As subsequent (undropped) sensor data instances are reported by the sensor, the tensor can be updated and an updated sampling rate determined for the particular sensor. Each time the sampling rate is determined, the new sampling rate can be communicated to the particular sensor.

Turning to FIG. 8C, a simplified flowchart 800c is shown illustrating an example technique for sampling data at a sensor device. The sensor can conduct a stream of readings to assess attributes of is surrounding environment. Corresponding to these readings, instances of sensor reading data can be generated. For instance, a sensor reading instance can be determined 875 (e.g., by determining that a next reading is to be conducted or by determining that a most recent reading has completed and generated a corresponding sensor reading data instance). The sensor device hosting the sensor (e.g., utilizing sampling logic implemented in hardware and/or software on the sensor device) can determine whether a sampling rate has been received or otherwise indicated (at 880) to be applied to readings of the sensor. If not sampling rate is received, active, or otherwise available for the sensor, the sensor device can cause the sensor reading instance to proceed, resulting in generated sensor reading instance data to be sent 885 to a data management system. If a sampling rate has been received (e.g., from the data management system) to be applied to the sensor, the sensor device can determine 890 whether the current sensor reading instance is to be dropped (at 890). For instance, the sensor device can generate a random number and compare the received sampling rate, or probability value, against the random number to determine whether or not this is one of the readings instances that should be dropped. If so, the current reading instance is dropped 892, either by skipping the taking of the current reading or by not reporting the data generated from completion of the current reading. In some instances, data generated from a reading instance that was dropped can be stored locally 894 at the sensor device. If the sensor device determines 890 that the reading instance is not to be dropped, data generated from completion of the sensor reading instance can be sent or reported 885 to the data management system. In cases where an initial sampling rate has been determined and received for the sensor, it can be anticipated that the sampling rate will be continually updated for each sensor reading instance. Indeed, the sampling rate can be determined at every time step (regardless of whether a new sensor reading was received at the time step. In other words, the data management system can perform a tensor factorization update at every time step (e.g., every second, minute, fraction of second, or other periodic time step defined for the system. Accordingly, an updated sampling rate can be received 895 to be applied at the next sensor reading instance, and so on.

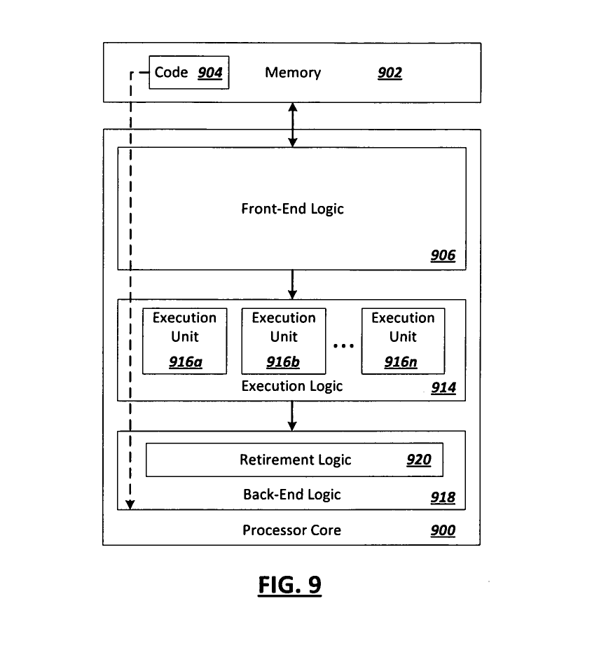

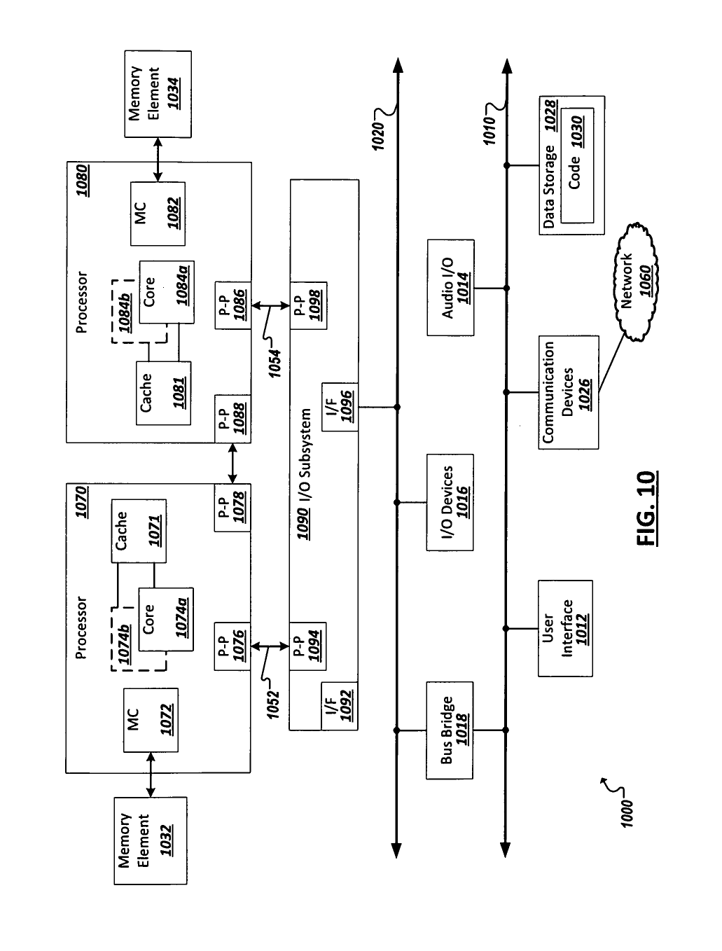

FIGS. 9-10 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 9-10.

FIG. 9 is an example illustration of a processor according to an embodiment. Processor 900 is an example of a type of hardware device that can be used in connection with the implementations above. Processor 900 may be any type of processor, such as a microprocessor, an embedded processor, a digital signal processor (DSP), a network processor, a multi-core processor, a single core processor, or other device to execute code. Although only one processor 900 is illustrated in FIG. 9, a processing element may alternatively include more than one of processor 900 illustrated in FIG. 9. Processor 900 may be a single-threaded core or, for at least one embodiment, the processor 900 may be multi-threaded in that it may include more than one hardware thread context (or “logical processor”) per core.

FIG. 9 also illustrates a memory 902 coupled to processor 900 in accordance with an embodiment. Memory 902 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 900 can execute any type of instructions associated with algorithms, processes, or operations detailed herein. Generally, processor 900 can transform an element or an article (e.g., data) from one state or thing to another state or thing.

Code 904, which may be one or more instructions to be executed by processor 900, may be stored in memory 902, or may be stored in software, hardware, firmware, or any suitable combination thereof, or in any other internal or external component, device, element, or object where appropriate and based on particular needs. In one example, processor 900 can follow a program sequence of instructions indicated by code 904. Each instruction enters a front-end logic 906 and is processed by one or more decoders 908. The decoder may generate, as its output, a micro operation such as a fixed width micro operation in a predefined format, or may generate other instructions, microinstructions, or control signals that reflect the original code instruction. Front-end logic 906 also includes register renaming logic 910 and scheduling logic 912, which generally allocate resources and queue the operation corresponding to the instruction for execution.

Processor 900 can also include execution logic 914 having a set of execution units 916a, 916b, 916n, etc. Some embodiments may include a number of execution units dedicated to specific functions or sets of functions. Other embodiments may include only one execution unit or one execution unit that can perform a particular function. Execution logic 914 performs the operations specified by code instructions.

After completion of execution of the operations specified by the code instructions, back-end logic 918 can retire the instructions of code 904. In one embodiment, processor 900 allows out of order execution but requires in order retirement of instructions. Retirement logic 920 may take a variety of known forms (e.g., re-order buffers or the like). In this manner, processor 900 is transformed during execution of code 904, at least in terms of the output generated by the decoder, hardware registers and tables utilized by register renaming logic 910, and any registers (not shown) modified by execution logic 914.

Although not shown in FIG. 9, a processing element may include other elements on a chip with processor 900. For example, a processing element may include memory control logic along with processor 900. The processing element may include I/O control logic and/or may include I/O control logic integrated with memory control logic. The processing element may also include one or more caches. In some embodiments, non-volatile memory (such as flash memory or fuses) may also be included on the chip with processor 900.

FIG. 10 illustrates a computing system 1000 that is arranged in a point-to-point (PtP) configuration according to an embodiment. In particular, FIG. 10 shows a system where processors, memory, and input/output devices are interconnected by a number of point-to-point interfaces. Generally, one or more of the computing systems described herein may be configured in the same or similar manner as computing system 1000.

Processors 1070 and 1080 may also each include integrated memory controller logic (MC) 1072 and 1082 to communicate with memory elements 1032 and 1034. In alternative embodiments, memory controller logic 1072 and 1082 may be discrete logic separate from processors 1070 and 1080. Memory elements 1032 and/or 1034 may store various data to be used by processors 1070 and 1080 in achieving operations and functionality outlined herein.

Processors 1070 and 1080 may be any type of processor, such as those discussed in connection with other figures. Processors 1070 and 1080 may exchange data via a point-to-point (PtP) interface 1050 using point-to-point interface circuits 1078 and 1088, respectively. Processors 1070 and 1080 may each exchange data with a chipset 1090 via individual point-to-point interfaces 1052 and 1054 using point-to-point interface circuits 1076, 1086, 1094, and 1098. Chipset 1090 may also exchange data with a high-performance graphics circuit 1038 via a high-performance graphics interface 1039, using an interface circuit 1092, which could be a PtP interface circuit. In alternative embodiments, any or all of the PtP links illustrated in FIG. 10 could be implemented as a multi-drop bus rather than a PtP link.

Chipset 1090 may be in communication with a bus 1020 via an interface circuit 1096. Bus 1020 may have one or more devices that communicate over it, such as a bus bridge 1018 and I/O devices 1016. Via a bus 1010, bus bridge 1018 may be in communication with other devices such as a user interface 1012 (such as a keyboard, mouse, touchscreen, or other input devices), communication devices 1026 (such as modems, network interface devices, or other types of communication devices that may communicate through a computer network 1060), audio I/O devices 1014, and/or a data storage device 1028. Data storage device 1028 may store code 1030, which may be executed by processors 1070 and/or 1080. In alternative embodiments, any portions of the bus architectures could be implemented with one or more PtP links.

The computer system depicted in FIG. 10 is a schematic illustration of an embodiment of a computing system that may be utilized to implement various embodiments discussed herein. It will be appreciated that various components of the system depicted in FIG. 10 may be combined in a system-on-a-chip (SoC) architecture or in any other suitable configuration capable of achieving the functionality and features of examples and implementations provided herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. One or more embodiments may provide a method, a system, a machine readable storage medium with executable code to identify a plurality of sensor data instances from a sensor device, determine at least one tensor for a data set based on the plurality of sensor data instances, determine a predicted value for each instance in the data set based on the tensor, determine a predicted variance for each instance in the data set based on tensor, and determine a sampling rate to be applied at the sensor device based on the predicted variances.

In one example, the sampling rate corresponds to a probability that sensor data dropped by the sensor device, and applying the sampling rate at the sensor device causes the sensor device to drop at least a portion of subsequent sensor data instances.

In one example, values of dropped sensor data instances are determined based on the tensor.

In one example, at least a portion of the values of dropped sensor data instances are determined through interpolation.

In one example, the plurality of sensor data instances correspond to instances in the data set and values of at least a portion of the instances of the data set are missing.

In one example, the sensor device is a particular one of a plurality of sensor devices and a respective tensor and a respective sampling rate are determined based on the corresponding tensor for each sensor of each of the plurality of sensor devices.

In one example, at least one of the plurality of sensor devices includes a plurality of sensors.

In one example, the tensor includes a 3-dimensional tensor with a spatial dimension, modality dimension, and temporal dimension.

In one example, the instructions, when executed, further cause the machine to determine, for each sensor data instance, a modality, a spatial location, and a timestamp of the sensor data instance.

In one example, tensor factorization is utilized to determine the predicted value and the predicted variance for each instance in the data set.

One or more embodiments may provide an apparatus including a sensor to detect attributes of an environment and generate sensor data instances describing the attributes, each sensor data instance corresponds to a reading of the sensor. The apparatus can include sampling logic to receive a signal over a network, where the signal indicates a sampling rate to be applied to the sensor, and apply the sampling rate to cause at least a portion of the sensor data instances to be dropped according to the sampling rate. The apparatus can include a transmitter to send undropped sensor data instances to a data management system.

In one example, the sampling logic is to receive a subsequent signal indicating an updated sampling rate to be applied to the sensor in response to a particular undropped sensor data instance sent to the data management system.

In one example, the sampling rate is based on a tensor corresponding to data generated by the sensor and each undropped sensor data instance cause the tensor and the sampling rate to be updated.

In one example, the apparatus includes a random number generator to generate, for each sensor data instance of the sensor, a random number, and applying the sampling rate includes determining a current value of the sampling rate, for each sensor data instance, comparing the sampling rate to the random number, and determining whether to drop the corresponding sensor data instance based on the comparing.

In one example, dropping a sensor data instance includes skipping the corresponding reading.

In one example, dropping a sensor data instance includes not sending the sensor data instance generated by the sensor.

In one example, the sensor includes a first sensor and the apparatus further includes at least a second additional sensor, and a respective sampling rate is received for each of the first and second sensors and updated based on respective sensor data instances generated by the corresponding sensor.

One or more embodiments may provide a method, a system, a machine readable storage medium with executable code to receive, over a network, a plurality of sensor data instances from a sensor device, determine a predicted value for each instance in the data set, determining a predicted variance for each instance in the data set, and determine a sampling rate to be applied at the sensor device based on the predicted variances.

In one example, at least one tensor for a data set can be determined based on the plurality of sensor data instances, and the predicted value and predicted variance for each instance in the data set are determined based on the at least one tensor.

In one example, a signal is sent to the sensor device indicating the determined sampling rate.

In one example, another data instance is received generated by the sensor device, the tensor is updated based on the other data instance, an updated sampling rate is determined based on the update to the tensor, and a signal is sent to the sensor device indicating the updated sampling rate.

One or more embodiments may provide a system including at least one processor, at least one memory element, and a data manager. The data manager can be executable by the at least one processor to receive, over a network, a plurality of sensor data instances from a sensor device, determine at least one tensor for a data set based on the plurality of sensor data instances, determine a predicted value for each instance in the data set based on the tensor, determine a predicted variance for each instance in the data set based on the tensor, and determine a sampling rate to be applied at the sensor device based on the predicted variances.

In one example, the system can include the sensor device, and the sensor device can apply the sampling rate to drop at least a portion of subsequent sensor data instances generated at the sensor device.

In one example, the data manager is further executable to predict values for the dropped portion of the subsequent data instances based on the tensor.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. At least one machine accessible storage medium having code stored thereon, the code when executed on a machine, causes the machine to:
identify a plurality of sensor data instances from a sensor device;
determine at least one tensor for a data set based on the plurality of sensor data instances;
determine a predicted value for each instance in the data set based on the tensor;
determine a predicted variance for each instance in the data set based on tensor; and
determine a sampling rate to be applied at the sensor device based on the predicted variances.

2. The storage medium of claim 1, wherein the sampling rate corresponds to a probability that sensor data dropped by the sensor device, and applying the sampling rate at the sensor device causes the sensor device to drop at least a portion of subsequent sensor data instances.

3. The storage medium of claim 2, wherein the instructions, when executed, further cause the machine to determine values of dropped sensor data instances based on the tensor.

4. The storage medium of claim 3, wherein at least a portion of the values of dropped sensor data instances are determined through interpolation.

5. The storage medium of claim 1, wherein the plurality of sensor data instances correspond to instances in the data set and values of at least a portion of the instances of the data set are missing.

6. The storage medium of claim 1, wherein the sensor device is a particular one of a plurality of sensor devices and the instructions, when executed, further cause the machine to determine a respective tensor and a respective sampling rate based on the corresponding tensor for each sensor of each of the plurality of sensor devices.

7. The storage medium of claim 6, wherein at least one of the plurality of sensor devices comprises a plurality of sensors.

8. The storage medium of claim 1, wherein the tensor comprises a 3-dimensional tensor with a spatial dimension, modality dimension, and temporal dimension.

9. The storage medium of claim 8, wherein the instructions, when executed, further cause the machine to determine, for each sensor data instance, a modality, a spatial location, and a timestamp of the sensor data instance.

10. The storage medium of claim 1, wherein tensor factorization is utilized to determine the predicted value and the predicted variance for each instance in the data set.

11. An apparatus comprising:
a sensor to detect attributes of an environment and generate sensor data instances describing the attributes, wherein each sensor data instance corresponds to a reading of the sensor;
sampling logic to:
receive a signal over a network, wherein the signal indicates a sampling rate to be applied to the sensor; and
apply the sampling rate to cause at least a portion of the sensor data instances to be dropped according to the sampling rate; and
a transmitter to send undropped sensor data instances to a data management system.

12. The apparatus of claim 11, wherein the sampling logic is to receive a subsequent signal indicating an updated sampling rate to be applied to the sensor in response to a particular undropped sensor data instance sent to the data management system.

13. The apparatus of claim 12, wherein the sampling rate is based on a tensor corresponding to data generated by the sensor and each undropped sensor data instance cause the tensor and the sampling rate to be updated.

14. The apparatus of claim 11, further comprising a random number generator to generate, for each sensor data instance of the sensor, a random number, wherein applying the sampling rate comprises:
determining a current value of the sampling rate;
for each sensor data instance, comparing the sampling rate to the random number; and
determining whether to drop the corresponding sensor data instance based on the comparing.

15. The apparatus of claim 11, wherein dropping a sensor data instance comprises skipping the corresponding reading.

16. The apparatus of claim 11, wherein dropping a sensor data instance comprises not sending the sensor data instance generated by the sensor.

17. The apparatus of claim 11, wherein the sensor comprises a first sensor and the apparatus further comprises at least a second additional sensor, and a respective sampling rate is received for each of the first and second sensors and updated based on respective sensor data instances generated by the corresponding sensor.

18. A method comprising:
receiving, over a network, a plurality of sensor data instances from a sensor device;
determining a predicted value for each instance in the data set;
determining a predicted variance for each instance in the data set; and
determining a sampling rate to be applied at the sensor device based on the predicted variances.

19. The method of claim 18, further comprising determining at least one tensor for a data set based on the plurality of sensor data instances, wherein the predicted value and predicted variance for each instance in the data set are determined based on the at least one tensor.

20. The method of claim 19, further comprising:
receiving another data instance generated by the sensor device;
updating the tensor based on the other data instance;
determining an updated sampling rate based on the update to the tensor; and
sending a signal to the sensor device indicating the updated sampling rate.

21. The method of claim 18, further comprising sending a signal to the sensor device indicating the determined sampling rate.

22. A system comprising:
at least one processor;
at least one memory element; and
a data manager, executable by the at least one processor to:
receive, over a network, a plurality of sensor data instances from a sensor device;
determine at least one tensor for a data set based on the plurality of sensor data instances;
determine a predicted value for each instance in the data set based on the tensor;
determine a predicted variance for each instance in the data set based on the tensor; and
determine a sampling rate to be applied at the sensor device based on the predicted variances.

23. The system of claim 22, further comprising the sensor device, wherein the sensor device applies the sampling rate to drop at least a portion of subsequent sensor data instances generated at the sensor device.

24. The system of claim 23, wherein the data manager is further executable to predict values for the dropped portion of the subsequent data instances based on the tensor.

25. A system comprising:
means to receive, over a network, a plurality of sensor data instances from a sensor device;
means to determine at least one tensor for a data set based on the plurality of sensor data instances;
means to determine a predicted value for each instance in the data set based on the tensor;
means to determine a predicted variance for each instance in the data set based on the tensor; and
means to determine a sampling rate to be applied at the sensor device based on the predicted variances
